(19) United States
(12) Patent Application Publication
(10) Pub. No.: US 2012/0112971 A1
(43) Pub. Date: May 10, 2012

(54) ANTENNA UNIT AND PORTABLE WIRELESS DEVICE EQUIPPED WITH THE SAME

(75) Inventors: Kazuhiko Takeyama, Ishikawa (JP); Kenji Yanagi, Kanagawa (JP); Masao Otani, Kanagawa (JP)

(73) Assignee: PANASONIC CORPORATION, Osaka (JP)

(21) Appl. No.: 13/380,356

(22) PCT Filed: Apr. 28, 2010
(86) PCT No.: PCT/JP2010/003070

§ 371 Date: Dec. 22, 2011

(30) Foreign Application Priority Data
Jun. 24, 2009 (JP) 2009-150009
Mar. 11, 2010 (JP) 2010-054642

(51) Int. Cl. H01Q 7/00; H01Q 1/24

(52) U.S. Cl. 343/702; 343/866

(57) ABSTRACT

It is an object to provide an antenna unit capable of operating in response to a plurality of types of counterpart equipment that operate at different resonance frequencies while enhancing its passing characteristic, as well as providing a portable wireless device equipped with the antenna unit. An antenna unit that performs wireless communication originating from induction coupling includes a loop antenna coiled by a conductor in a planar shape; and a metallic plate that is positioned while displaced from the loop antenna in one direction and that partially encloses a circumference of the loop antenna when viewed from the direction, wherein each of ends of the metallic plate overlaps a portion of the loop antenna when viewed from the direction.

### TECHNICAL FIELD

The present invention relates to an antenna unit used in a portable wireless device, like an IC card, of an RFID system, as well as relating to a portable wireless device equipped with the antenna unit.

### BACKGROUND ART

An RFID (Radio Frequency Identification) system is generally used in electronic money, or the like. Communication between an RFID card or a mobile device (a portable wireless device) that is an RFID-containing device and its counterpart equipment [a reader/writer (R/W)] that is a stationary machine disposed in a shop, or the like, is performed through wireless communication caused by electromagnetic induction (induction coupling). A wireless communication technique based on electromagnetic induction allows establishment of communication only within a range where a high degree of coupling exists between an antenna of the mobile device and an antenna of the counterpart equipment, and a communication distance is as short as about one meter. FIG. 12 is a diagram showing a rough configuration of a related art RFID system. As shown in FIG. 12, a communication distance between the mobile device and the counterpart equipment is specified by a vertical distance between a center position of a loop antenna 31 of the counterpart equipment designated by mark 32 and a mobile device 40. In general, the communication distance has a correlation with an aperture area of an antenna of the mobile device.

As a device equipped with an RFID device becomes smaller, a demand for a smaller antenna of a mobile device is now growing. In order to increase a communication distance that becomes shorter with a decrease in the size of antenna coil, placing a booster coil in a neighborhood of an antenna coil of an RFID mobile device has hitherto been put forward (see; for instance, Patent Document 1).

FIG. 13 shows a block diagram showing a rough configuration of an antenna block of the related art mobile device shown in FIG. 12 and FIG. 14 shows an equivalent circuit of the antenna block of the related art mobile device shown in FIG. 13. As shown in FIG. 14, a booster coil 46 having a resonance element 45 is placed in a vicinity of an RFID section 44 of the mobile device 40 including a loop antenna 41, a resonance circuit 42, and a communication circuit block 43, thereby increasing a resonance Q value of the RFID circuit of the mobile device 40. The loop antenna 41 of the mobile device 40 establishes communication with counterpart equipment 30 having the loop antenna 31 and a communication circuit block 33 by way of the booster coil 46, thereby extending a communication distance.

### RELATED ART DOCUMENT

### <Patent Document>

Patent Document 1: JP-A-2004-29873

### DISCLOSURE OF THE INVENTION

### <Problem That the Invention is to Solve>

However, under the method for increasing the resonance Q value by providing the mobile device with the booster coil, a frequency band where an S21 characteristic becomes smaller as well as a frequency band where the S21 characteristic increases develop. FIG. 15 shows a frequency response characteristic (an S21 characteristic) of a power gain achieved between points A and B in the equivalent circuit shown in FIG. 14. A vertical axis of FIG. 15 represents an S21 characteristic [dB], and a horizontal axis of FIG. 15 represents a frequency [MHz]. A point A is an output terminal of a communication circuit block of the counterpart equipment, whilst a point B is an input terminal of a communication circuit block of the mobile device. A curve 1 shown in FIG. 15 depicts an S21 characteristic achieved when the mobile device is not equipped with a booster coil, whilst a curve 2 shown in FIG. 15 depicts an S21 characteristic achieved when the mobile device is equipped with the booster coil.

As shown in FIG. 15, the curve 2 includes a peak at a resonance frequency f0 that is steeper than that of the curve 1. The curve 2 also has another middle-size peak at a frequency that is higher than f0. A large droop exists in the S21 characteristic at a wide frequency band between f0 and the other peak. Specifically, when the mobile device is equipped with the booster coil, the S21 characteristic can be improved at a specific resonance frequency (the resonance frequency f0 in FIG. 15), but the S21 characteristic is not improved in another frequency band. As a consequence, a communication distance between the mobile device and the counterpart equipment can be extended only at a specific resonance frequency.

In general, there are many types of RFID counterpart equipment, and a resonance frequency changes according to counterpart equipment. FIGS. 16 and 17 show an S21 characteristic of a mobile device that are exhibited in response to two different pieces of counterpart equipment having different resonance frequencies in a related-art RFID system. In FIGS. 16 and 17, a solid line represents an S21 characteristic yielded when the mobile device has a booster coil, whilst a broken line represents an S21 characteristic yielded when the mobile device does not have any booster coil. Vertical axes in the drawings show an S21 characteristic [dB], whereas horizontal axes in the same show a frequency [MHz].

In FIG. 16, the peak of the solid line is positionally lower than the peak of the broken line. In the meantime, in FIG. 17 showing a case of a resonance frequency differing from that shown in FIG. 16, the peak of the solid line is positionally higher than the peak of the broken line. Consequently, even when the booster coil is incorporated in the mobile device, the S21 characteristic is improved at the specific resonance frequency shown in FIG. 17 when compared with a case where the mobile device is not equipped with the booster coil. However, the S21 characteristic is not improved at the other specific resonance frequency shown in FIG. 16. Therefore, even when the mobile device is equipped with the booster coil, the mobile device cannot cope with a plurality of pieces of counterpart equipment that operate at different resonance frequencies.

As mentioned above, in the related art RFID system, the mobile device can be applied to one counterpart equipment that operates at a certain specific frequency but cannot be applied to a plurality of pieces of counterpart equipment that operate at other specific frequencies.

Accordingly, the present invention aims at providing an antenna unit and a portable wireless device that is equipped with the antenna unit and capable of operating in response to a plurality of types of counterpart equipment having different resonance frequencies while improving its passing characteristic.

### <Means for Solving the Problem>

As one embodiment of the present invention, there is provided an antenna unit that performs wireless communication originating from induction coupling, the antenna unit comprising a loop antenna coiled by a conductor in a planar shape and a metallic plate that partially encloses a circumference of the loop antenna and that is placed on a same plane where the loop antenna is provided.

As one embodiment of the present invention, there is provided an antenna unit that performs wireless communication originating from induction coupling, the antenna unit comprising a loop antenna coiled by a conductor in a planar shape and a metallic plate that is positioned while displaced from the loop antenna in one direction and that partially encloses a circumference of the loop antenna when viewed from the one direction, wherein each of ends of the metallic plate overlaps a portion of the loop antenna when viewed from the direction.

In the antenna unit, each of the ends of the metallic plate lies between the innermost coil portion and the outermost coil portion of the coil of the loop antenna.

In the antenna unit, the metal plate is made of a flexible material.

In another embodiment of the present invention, there is provided a portable wireless device having the antenna unit incorporated in an enclosure.

In the portable wireless device, the metallic plate of the antenna unit is made up of a metallic enclosure of the portable wireless device.

### <Advantage of the Invention>

The present invention can provide an antenna unit capable of operating in response to a plurality of types of counterpart equipment having different resonance frequencies while improving its passing characteristic and a portable wireless device having the antenna unit.

### BRIEF DESCRIPTION OF THE DRAWINGS

FIG. 1 is a plan view of an antenna unit 1 of a first embodiment.

FIG. 2 (a) is a graph showing an S21 characteristic exhibited when a mobile device equipped with the antenna unit 1 operates in response to counterpart equipment that operates at a specific resonance frequency and an S21 characteristic exhibited when a mobile device equipped with a related art antenna unit operates in response to the counterpart equipment; FIG. 2(b) is a graph showing an S21 characteristic exhibited when the mobile device equipped with the antenna unit 1 operates in response to the other counterpart equipment that operates at a resonance frequency differing from the resonance frequency employed in FIG. 2(a) and an S21 characteristic exhibited when the mobile device equipped with the related art antenna unit operates in response to the counterpart equipment; and FIG. 3(c) it is a graph showing RP terminal voltages achieved when the mobile device equipped with the antenna unit 1 is used in response to ten types of counterpart equipment having different resonance frequencies.

FIG. 3 (a) is a schematic for explaining the size of a metallic plate 3 of the antenna unit 1; FIG. 3(b) is a schematic showing an example of the metallic plate 3; and FIG. 3(c) is a schematic showing another example of the metallic plate 3.

FIG. 4 (a) is a schematic for explaining a process (1) of a shielding method employed when the portable wireless device is equipped with the antenna unit 1; FIG. 4 (b) it is a schematic for explaining a process (2) of the shielding method employed when the portable wireless device is equipped with the antenna unit 1; and FIG. 4 (c) it is a schematic for explaining a process (3) of the shielding method employed when the portable wireless device is equipped with the antenna unit 1.

FIG. 5 is a schematic showing an example of a second embodiment in which a cell phone 10 is equipped with the antenna unit 1.

FIG. 6 is a descriptive view showing a case where the metallic plate 3 is added to a loop antenna of an existing cell phone.

FIG. 7 is a plan and cross sectional view of an antenna unit 23 of a third embodiment.

FIG. 8 is a simulation result of a passing characteristic of the antenna unit 23 of the embodiment and a passing characteristic of an antenna of its counterpart R/W.

FIG. 9 (a) is a schematic for explaining a size of a metallic plate 25 of the antenna unit 23; FIG. 9 (b) it is an example of the metallic plate 25; and FIG. 9 (c) shows another example of the metallic plate 25.

FIG. 10 (a) is a brief schematic of a cell phone 10A that is a portable wireless device having the antenna unit 23 incorporated; and FIG. 10 (b) is a schematic showing a cross section of an antenna block of the cell phone 10A.

FIG. 11 is an explanatory view showing a case where the metallic plate 25 is added to the loop antenna of the existing cell phone.

FIG. 12 is a schematic showing a rough configuration of a related art RFID system.

FIG. 13 is a block diagram showing a rough configuration of an antenna block of a mobile device shown in FIG. 12.

FIG. 14 is an equivalent circuit of the antenna block of the mobile device shown in FIG. 13.

FIG. 15 shows a frequency response characteristic of a power gain achieved between points A and B of the equivalent circuit shown in FIG. 14.

FIG. 16 is a graph showing an S21 characteristic of a mobile device in response to its counterpart equipment in the related art RFID system.

FIG. 17 is a graph showing S21 characteristic of the mobile device exhibited in response to another counterpart equipment in the related art RFID system.

### EMBODIMENTS FOR IMPLEMENTING THE INVENTION

Embodiments of the present invention are hereunder described by reference to the drawings.

### First Embodiment

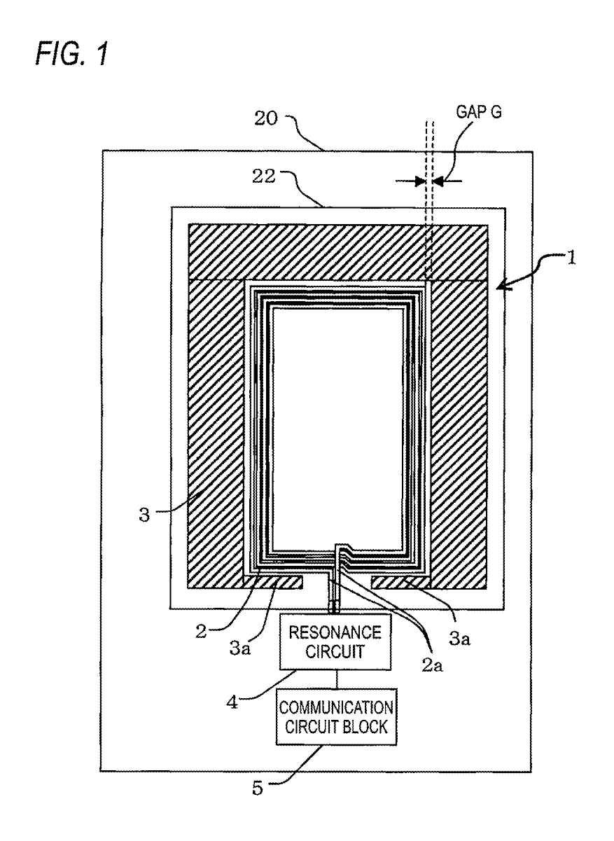

FIG. 1 is a plan view of an antenna unit 1 of a first embodiment. As shown in FIG. 1, the antenna unit 1 is set in an antenna block 22 of an RFID block 20 of a mobile device. The antenna unit 1 shown in FIG. 1 has a loop antenna 2 and a metallic plate 3 partially enclosing a circumference of the loop antenna 2 in the form of a loop.

The loop antenna 2 is used as a main antenna of the mobile device that is a portable radio unit of an RFID system. In this embodiment, the loop antenna is made up of a four-turn rectangular loop made of copper foil, or the like. Both ends 2a of the loop antenna 2 are pulled outside the metallic plate 3 from a center of a lower side of the rectangular shape and connected to a communication circuit block 5 by way of a resonance circuit 4 of the RFID block 20.

The metallic plate 3 is used as an auxiliary antenna for enhancing a gain of the loop antenna 2. In the present embodiment, the metallic plate 3 is formed into a rectangular loop made of copper foil, or the like. In the drawing, discontinuous open ends 3a are formed at the center of the lower side of the rectangular shape.

The essential requirement for the metallic plate 3 is to be provided substantially in the same plane where the loop antenna 2 is provided. In addition to being provided on the same plane made by the loop antenna 2, the metallic plate 3 can also be placed while displaced by about one to two millimeters from the plane in the vertical direction.

As shown in FIG. 1, a gap G (a horizontal distance) between the metallic plate 3 and the loop antenna 2 is dependent on a mobile device into which the antenna unit is to be incorporated. However, for instance, the gap ranges from 0.1 mm to 3 mm.

The essential requirement for the metallic plate 3 is to enclose the circumference of the loop antenna 2 in a partial manner. A discontinuous area where the metallic plate 3 does not enclose the circumference of the loop antenna 2 can be situated at any location around the loop antenna 2. The metallic plate 3 can be made of a single metallic plate or by joining a plurality of metallic plates.

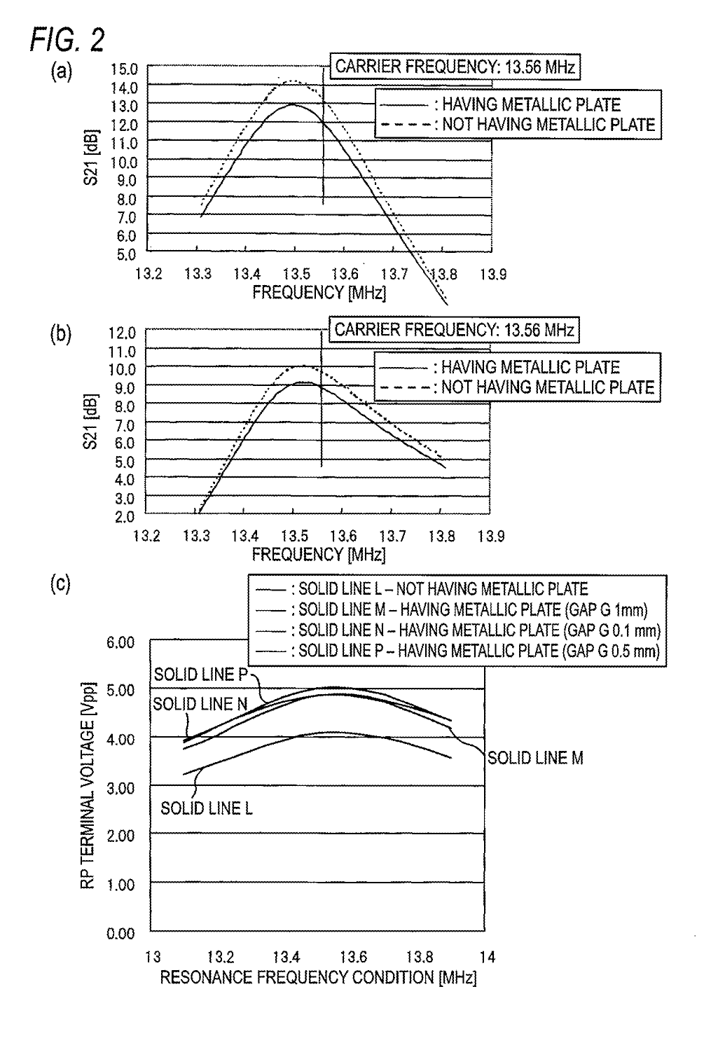

FIG. 2(a) to FIG. 2(c) show simulation results of RP terminal voltages acquired when the antenna unit 1 is used. FIG. 2(a) shows an S21 characteristic [dB] (denoted by a solid line in the drawing) exhibited when a mobile device equipped with the antenna unit 1 operates in response to counterpart equipment that operates at a specific resonance frequency and an S21 characteristic [dB] (denoted by a broken line in the drawing) exhibited when a mobile device equipped with a related art antenna unit not having the metallic plate 3 operates in response to the counterpart equipment. FIG. 2(b) shows an S21 characteristic [dB] (denoted by a solid line in the drawing) exhibited when the mobile device equipped with the antenna unit 1 operates in response to the other counterpart equipment that operates at a resonance frequency differing from the resonance frequency at which the counterpart equipment shown in FIG. 2(a) operates and an S21 characteristic [dB] (denoted by a broken line in the drawing) exhibited when the mobile device equipped with the related art antenna unit not having the metallic plate 3 operates in response to the counterpart equipment.

As shown in FIGS. 2(a) and 2(b), when compared with the mobile device equipped with the related art antenna unit that does not have the metallic plate 3, the mobile device having the antenna unit 1 can improve the S21 characteristic even in response to the plurality of counterpart equipment that operate at different resonance frequencies.

FIG. 2(c) shows a series of input terminal voltages (RP terminal voltages) of the communication circuit block 5 obtained when the mobile device equipped with the antenna unit 1 is used in response to ten types of counterpart equipment [including the pieces of counterpart equipment shown in FIGS. 2(a) and 2(b)] having different resonance frequencies. Respective solid lines denote changes in the gap G. A solid line L denotes a case where the metallic plate 3 is not used. A solid line M denotes a case where the gap G is one millimeter. A solid line N denotes a case where the gap G is 0.1 millimeter. A solid line P denotes a case where the gap G is 0.5 millimeter.

As shown in FIG. 2(c), in contrast with the case where the metallic plate 3 is not provided around the loop antenna 2, when the metallic plate 3 partially enclosing the circumference of the loop antenna 2 in the form of a loop is provided around the loop antenna 2 on the same plane, an RP terminal voltage of the mobile device; namely, an S21 characteristic of the mobile device equipped with the antenna unit 1, can be improved over a wide frequency band. Therefore, even when the resonance frequency of the counterpart equipment differs, the mobile device can be used to perform wireless communication over an increased communication distance in response to a plurality of types of counterpart equipment having different resonance frequencies.

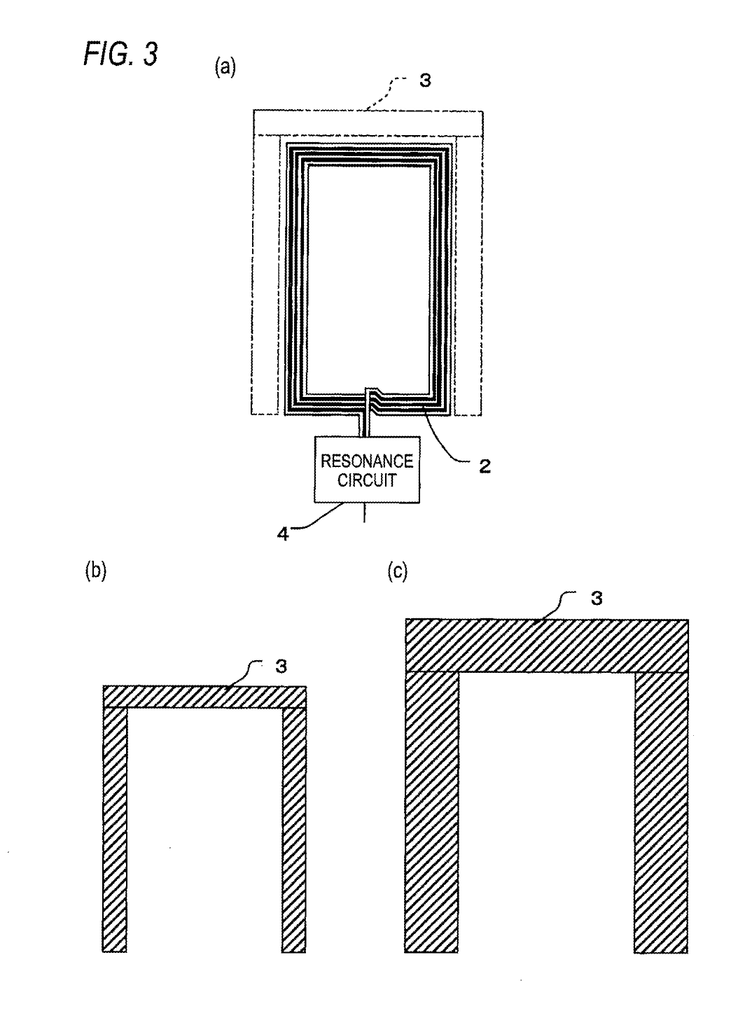

By reference to FIGS. 3(a) to 3(c), the size of the metallic plate 3 of the antenna unit 1 is now described. FIG. 3(a) is a schematic for describing the size of the metallic plate 3 of the antenna unit 1; FIG. 3(b) shows an example of the metallic plate 3; and FIG. 3(c) shows another example of the metallic plate 3.

As shown in FIG. 3(a), the size of metallic plate 3 denoted by a broken line in the drawing can be changed in conformity with the size of an enclosure of the mobile device into which the antenna unit 1 is incorporated.

As shown in FIG. 3(b), when the enclosure of the mobile device is small and when the space where the metallic plate 3 is placed is small, the metallic plate 3 is formed into a small size and used. As shown in FIG. 3(c), when the enclosure of the mobile device is large and when a space into which the metallic plate 3 is placed is large, the metallic plate 3 can be formed into a large size and used. As mentioned above, the size of the metallic plate 3 can be determined in conformance to the size of the enclosure of the mobile device used.

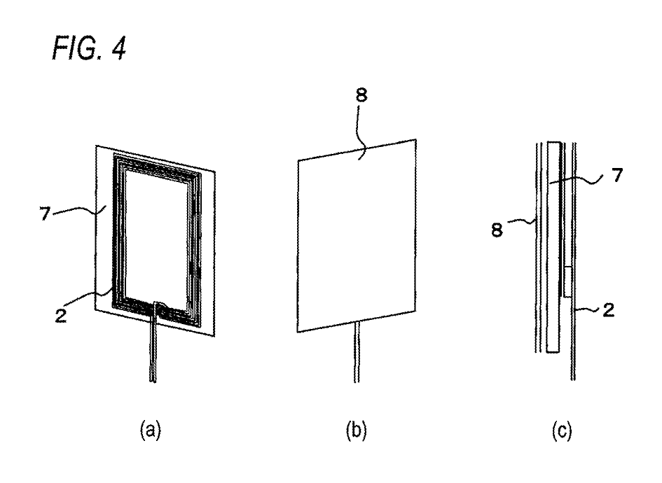

When the antenna unit 1 is incorporated into the mobile device, the loop antenna 2 is provided with an electromagnetic shield in order to block an electromagnetic field originating from an electronic device in the mobile device as shown in FIG. 4. FIG. 4(a) is a schematic for explaining a process (1) of a shielding method employed when a portable wireless device is equipped with the antenna unit 1. FIG. 4(b) is a schematic for explaining a process (2) of the shielding method employed when the portable wireless device is equipped with the antenna unit 1. FIG. 4(c) is a schematic for explaining a process (3) of the shielding method employed when the portable wireless device is equipped with the antenna unit 1. Specifically, a magnetic sheet 7 is put on a back of the loop antenna 2 [FIG. 4(a)]. A rear metallic plate 8 is put on a back of the magnetic sheet 7 [FIGS. 4(b) and (c)], thereby shielding the loop antenna 2. The metallic plate 3 is positioned around the thus-shielded loop antenna 2, and the antenna unit 1 is incorporated into the antenna block of the mobile device.

### Second Embodiment

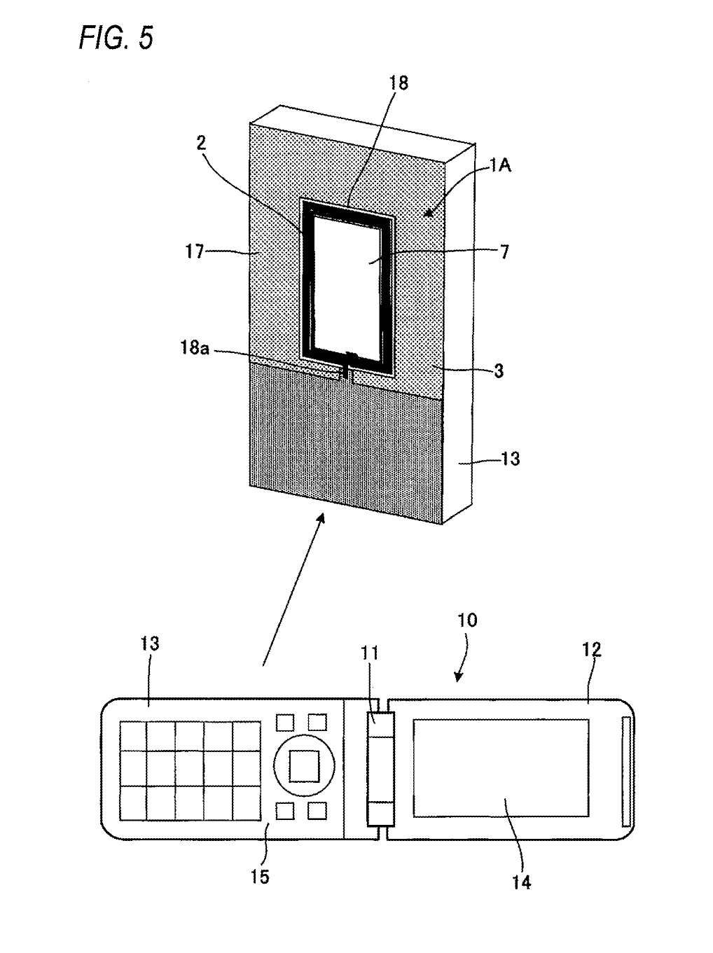

An explanation is given to, as a second embodiment of the present invention, a case where a portable wireless device is used as an example mobile device into which the antenna unit 1 of the present invention is incorporated. FIG. 5 shows an example where the antenna unit 1 of the present invention is incorporated into an enclosure of a cell phone 10 that is the portable wireless device.

The cell phone 10 shown in FIG. 5 has an upper enclosure body 12 and a lower enclosure body 13 that are reclosably joined together by means of a hinge 11. A display panel 14, or the like, is provided on a reclosable-side front surface of the upper enclosure body 12, and an operation block 15 having various operation buttons or keys is provided on a reclosable-side front surface of the lower enclosure body 13. In the present embodiment, when the cell phone 10 is assembled and produced, the antenna unit 1 of the present invention is incorporated.

An antenna block 1A is placed at a position close to the hinge 11 on a surface of the lower enclosure body 13 of the cell phone 10 that is on a back side of the operation section 15, and a bottom plate 17 of the lower enclosure body 13 of the antenna block 1A is made of a metallic plate. A rectangular hole 18 having a downward opening 18a formed in upper and lower sides of the metallic bottom plate 17 shown in FIG. 5 is bored in the bottom plate 17, whereby a discontinuous loop is formed from the opening 18a on the bottom plate 17. The back side (an interior of the enclosure body) of the loop antenna 2 is electromagnetically shielded by means of the magnetic sheet 7 and a rear metallic plate. The thus-electromagnetically-shielded loop antenna 2 is fitted into the rectangular hole 18 and adhesively fastened to a support within the lower enclosure body 13. The metallic plate 3 partially surrounding the circumference of the loop antenna 2 is formed by utilization of the bottom plate 17 of the lower enclosure body 13. The antenna unit 1 is made up of the loop antenna 2 and the bottom plate 17, and the antenna unit 1 is incorporated in the cell phone 10.

Although the bottom plate 17 of the lower enclosure body 13 of the antenna block 1A is formed from a metallic plate, the entirety of the lower enclosure body 13 can also be made up of a metallic plate.

In the embodiment, since the metallic plate 3 of the antenna unit 1 is formed on the bottom plate 17 in the metallic portion of the lower enclosure body 13 of the cell phone 10, the antenna unit 1 itself can be miniaturized.

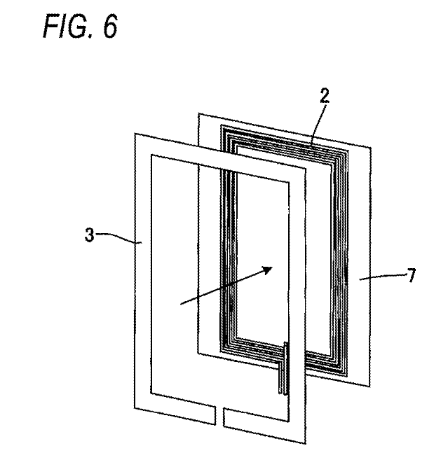

The present embodiment shows that the antenna unit 1 of the present invention is newly set at the time of production of the cell phone 10. However, as shown in FIG. 6, all you need to do is to affix the metallic plate 3 to the loop antenna 2 of the existing cell phone by means of a double-sided tape.

As a result, the antenna unit 1 of the present invention is built by use of the existing loop antenna 2, whereby antenna performance of the existing cell phone can thereby be improved.

Although the explanation has been given in the present embodiment by means of taking the cell phone as an example portable wireless device, the present invention is not limited to the cell phone. The present invention can be applied to any devices, so long as the device is used as a mobile device of an RFID system, like an RFID card and RFID-contained equipment.

### Third Embodiment

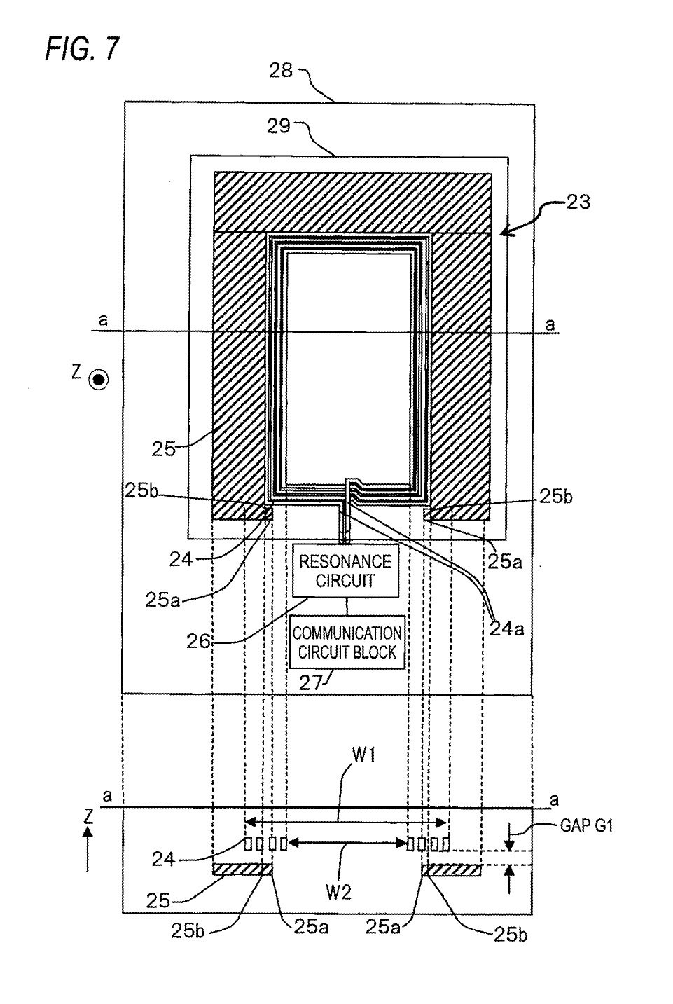

As mentioned above, the antenna units 1 of the first and second embodiments of the present invention contribute to improvements of the S21 characteristics. In relation to an antenna unit 23 of a third embodiment, another configuration for yielding a great effect of enhancing the S21 characteristic is now described. FIG. 7 is a plan and cross sectional view of the antenna unit 23 of the third embodiment. As shown in FIG. 7, the antenna unit 23 is placed in an antenna block 29 of an RFID block 28 of the mobile device. The antenna unit 23 shown in FIG. 7 has a loop antenna 24 and a metallic plate 25 that partially encloses a circumference of the loop antenna 24 like a loop.

The loop antenna 24 is used as a main antenna of the mobile device that is the portable wireless device of the RFID system. In the present embodiment, the loop antenna 24 is made up of a four-turn rectangular loop made of copper foil, or the like. In the drawing, both ends 24a of the loop antenna 24 are pulled outside the metallic plate 25 from a variable center of the rectangular shape and connected to a communication circuit block 27 by way of a resonance circuit 26 of the RFID block 28.

As shown in FIG. 7, a width existing in the first turn of the copper foil from the inner radius of the loop antenna 24 is taken as an inner width W2. Further, a width existing in the fourth turn from the inner radius of the loop antenna 24; namely, a width existing in the first turn of the copper foil from the outer radius of the loop antenna 24, is taken as an external width W1.

The metallic plate 25 is used as an auxiliary antenna for enhancing a gain of the loop antenna 24. In the present embodiment, the metallic plate 25 is formed from copper foil, or the like, into a rectangular loop shape. In the drawing, an outer turn is formed at the center of the lower side of the rectangular shape into discontinuous open ends 25a.

The metallic plate 25 is positioned while displaced from the loop antenna 24 in a vertical direction (i.e., a direction Z in FIG. 7). When viewed from a cross section that is substantially orthogonal to the vertical direction (the direction Z in FIG. 7), each of ends 25b of the metallic plate 25 exist between the inner width W2 and the outer width W1 of the loop antenna 24. Moreover, the metallic plate 25 has the open ends 25a continued from the respective ends 25b of the metallic plate 25. In the embodiment, the metallic plate 25 is formed from copper foil, or the like, into a rectangular loop. In the drawing, the discontinuous open ends 25a are formed at the center of the lower side of the rectangular shape. Although the open ends 25a continued from the respective ends 25b of the metallic plate 25 are provided, the ends 25b themselves may also form open ends.

When viewed from the vertical direction (the direction Z in FIG. 7), each of the ends 25b of the metallic plate 25 is situated between the copper foil making up the outermost turn of the loop antenna 24 and the copper foil making up the innermost turn of the loop antenna 24.

As shown in FIG. 7, a gap G1 (a vertical distance) between the metallic plate 25 and the loop antenna 24 depends on the mobile device into which the antenna unit 23 is incorporated; however, it ranges, for instance, from 0.1 mm to 3 mm.

Although the essential requirement for the metallic plate 25 is to partially enclose the circumference of the loop antenna 24, each of the ends 25b of the metallic plate 25 lies, in the present embodiment, at a position where the end overlaps its corresponding loop antenna 24 when viewed from the vertical direction (the direction Z in FIG. 7). When viewed from a cross section substantially orthogonal to the vertical direction (the direction Z in FIG. 7), the ends 25b of the metallic plate 25 lie between the inner width W2 and the outer width W1 of the loop antenna 24. The metallic plate 25 may also be formed from a single metallic plate or by joining together a plurality of metallic plates.

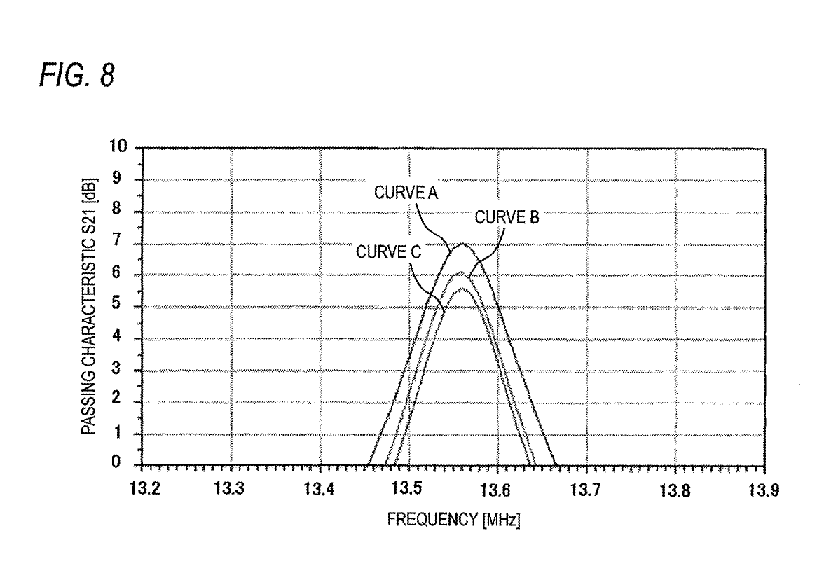

FIG. 8 shows a simulation result of passing characteristics of the antenna unit 23 of the present embodiment and the antenna of the R/W of the counterpart equipment that operates at a specific resonance frequency. By way of example, FIG. 8 shows simulation results. Specifically, when a coil of the copper foil of the loop antenna 24 of the antenna unit 23 has three turns, the passing characteristic S21 is achieved when the position of the open ends 25a of the metallic plate 25 are changed between the inner width W2 and the outer width W1 of the loop antenna 24. The vertical axis in FIG. 8 represents the passing characteristic S21 [dB], and the horizontal axis in FIG. 8 represents a frequency [MHz] achieved during the simulation.

For comparison, a curve C shown in FIG. 8 represents a simulation result yielded when the metallic plate 25 is not provided. A curve B shown in FIG. 8 represents a simulation result yielded when the ends 25b of the metallic plate 25 lie between the inner width W2 and the outer width W1 of the loop antenna 24. For comparison, a curve A shown in FIG. 8 represents a simulation result yielded when the ends 25b of the metallic plate 25 are situated outside the outermost coil of the loop antenna 24.

As denoted by the curve B shown in FIG. 8, when the ends 25b of the metallic plate 25 are situated between the inner width W2 and the outer width W1 of the loop antenna 24, the passing characteristic S21 becomes most favorable. Moreover, when the ends 25b of the metallic plate 25 do not lie between the inner width W2 and the outer width W1 of the loop antenna 24; namely, in the case of the curve A and the curve C shown in FIG. 8, the passing characteristic S21 are lower than the curve B shown in FIG. 8. Therefore, when the ends 25b of the metallic plate 25 lie between the inner width W2 and the outer width W1 of the loop antenna 24, the passing characteristic S21 can be improved when compared with a case where the ends 25b do not lie between the inner width W2 and the outer width W1 of the loop antenna 24.

As denoted by the curve B shown in FIG. 8, when the ends 25b of the metallic plate 25 lie between the inner width W2 and the outer width W1 of the loop antenna 24, the passing characteristic S21 can be improved over a wide frequency band. Therefore, even when counterpart equipment operates at a different resonance frequency, wireless communication can be established over a longer communication distance by use of a mobile device in response to a plurality of types of counterpart equipment that operate at different resonance frequencies.

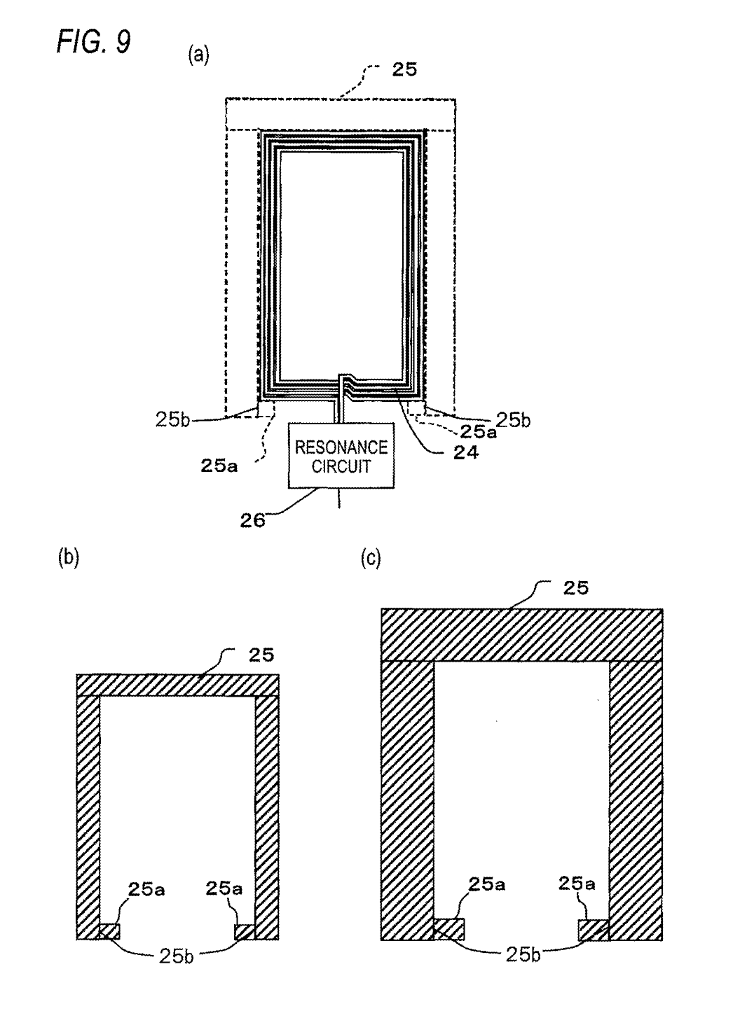

By reference to FIGS. 9(a) to 9(c), the size of the metallic plate 25 of the antenna unit 23 is now described. FIG. 9(a) is a schematic for describing the size of the metallic plate 25 of the antenna unit 23. FIG. 9(b) shows an example of the metallic plate 25. FIG. 9(c) shows another example of the metallic plate 25.

As shown in FIG. 9(a), the size of the metallic plate 25 designated by a broken line in the drawing can be changed in agreement with the size of the enclosure of the mobile device into which the antenna unit 23 is incorporated. Although the open ends 25a continued form the respective ends 25b of the metallic plate 25 are provided, the ends 25b themselves can also be formed as open ends.

As shown in FIG. 9(b), when the enclosure of the mobile device is small and when a space where the metallic plate 25 is to be provided is small, the metallic plate 25 is formed and used in a small size. Although the open ends 25a that are continued from the respective ends 25b of the metallic plate 25, are provided, the ends 25b themselves can also be formed as open ends.

As shown in FIG. 9(c), when the enclosure of the mobile device is large and when the space where the metallic plate 25 is to be provided is large, the metallic plate 25 can be formed and used in a large size. As mentioned above, the size of the metallic plate 25 can be determined in conformance to the size of the enclosure of a mobile device used. Although the open ends 25a continued from the ends 25b of the metallic plate 25 are provided, the ends 25b themselves can also be open ends.

When compared with the case where the ends 25b of the metallic plate 25 do not lie between the inner width W2 and the outer width W1 of the loop antenna 24, when the ends 25b of the metallic plate 25 lie between the inner width W2 and the outer width W1 of the loop antenna 24, the antenna unit 23 of the embodiment can improve the passing characteristic S21. Further, even when the counterpart equipment operates at a different resonance frequency, wireless communication can be established over a longer communication distance by use of a mobile device in response to a plurality of types of counterpart equipment that operate at different resonance frequencies.

### Fourth Embodiment

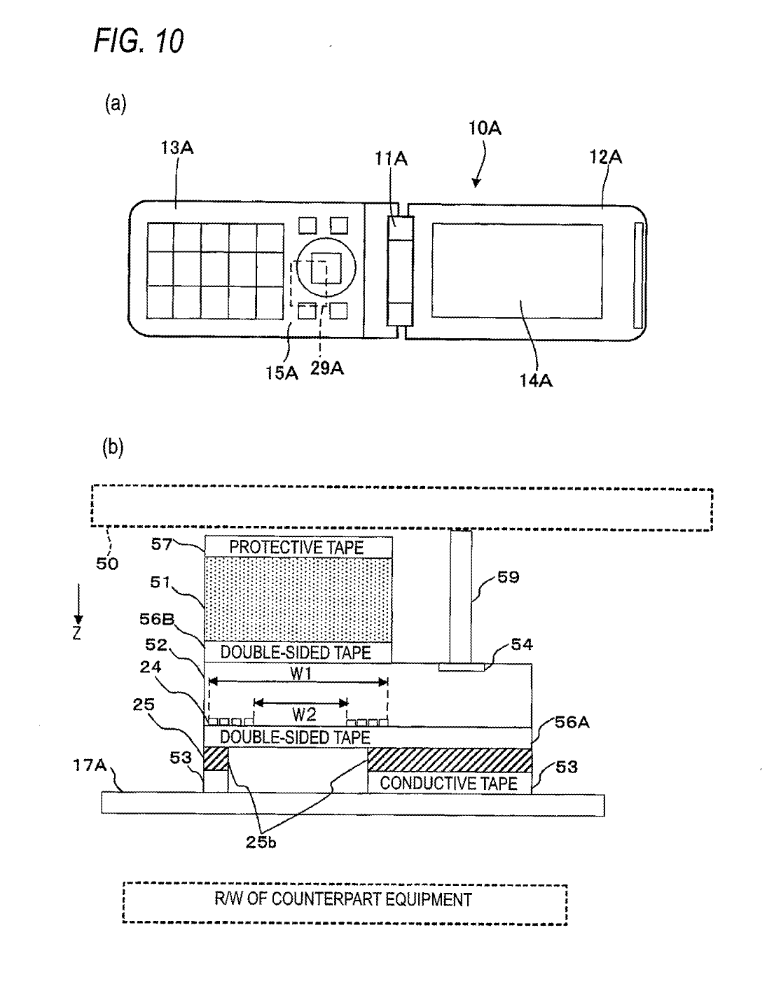

By reference to FIGS. 10(a) and 10(b), an explanation is now given to, as a fourth embodiment of the present invention, a case where a portable wireless device is used as an example of a mobile device into which the antenna unit 23 of the third embodiment is to be incorporated. FIG. 10(a) is a brief schematic of a cell phone 10A that is a portable wireless device having the antenna unit 23 incorporated. FIG. 10(b) is a schematic showing a cross section of an antenna block of the cell phone 10A. In the present embodiment, the open ends 25a continued from the respective ends 25b of the metallic plate 25 are not provided, and the ends 25b themselves also double as open ends.

The cell phone 10A shown in FIG. 10(a) has an upper enclosure body 12A and a lower enclosure body 13A that are reclosably joined together by way of a hinge 11A. A reclosable-side surface of the upper enclosure body 12A has a display panel 14A, or the like. An operation block 15A including various operation buttons and operation keys is provided on a reclosable-side surface of the lower enclosure body 13A. In the embodiment, the antenna unit 23 of the third embodiment is built in during assembly of the cell phone 10A.

As shown in FIG. 10(a), an antenna block 29A is placed at a position close to the hinge 11A on the back side of the operation block 15A of the lower enclosure body 13A of the cell phone 10A. The metallic plate 25 is fixed to an interior surface of a bottom plate 17A of the lower enclosure body 13A of the antenna block by means of a conductive tape 53 [see FIG. 10(b)].

As shown in FIG. 10(b), the lower enclosure body 13A includes the metallic plate 25 fixed to an interior surface of the bottom plate 17A of the lower enclosure body 13A opposing the R/W of the counterpart equipment by means of the conductive tape 53; an antenna substrate 52 and an antenna contact point 54 that are fixed, by means of a double-sided tape 56A, to the other side of the surface of the metallic plate 25 opposing the lower enclosure body 13A; a magnetic sheet 51 fixed, by means of a double-sided tape 56B, to the other side of the surface of the antenna substrate 52 opposing the metallic plate 25; a protective tape 57 bonded to the other side of the surface of the magnetic sheet 51 opposing the antenna substrate 52, to thus protect the magnetic sheet 51; and a substrate 50 connected, by way of a spring 59, to the other side of the antenna contact point 54 opposite to its surface facing the metallic plate 25.

The ends 25b of the metallic plate 25 lie between the inner width W2 and the outer width W1 of the loop antenna 24 in a thicknesswise direction (the Z direction in the drawing) of the lower enclosure body 13A.

Circuitry for controlling the display panel 14A and the operation block 15A; namely, the resonance circuit 26 and the communication circuit block 27 shown in FIG. 7, is populated on the substrate 50.

The magnetic sheet 51 is a flexible magnetic sheet. The magnetic sheet 51 is provided so as to fulfill communication standards required for the antenna unit 23 to establish communication with the R/W of the counterpart equipment.

The loop antenna 24 making up the antenna unit 23 is formed on the antenna substrate 52.

The conducive tape 53 fastens the metallic plate 25 to an interior surface of the lower enclosure body 13A opposing the RAN of the counterpart equipment. Further, since the conductive tape 53 exhibits electrical conductivity, the lower enclosure body 13A that is partially or entirely formed from metal can be deemed to be a portion of the metallic plate 25, so that the characteristic of the antenna unit 23 can be enhanced.

In the above, as in the third embodiment, when compared with a case where the ends 25b do not lie between the inner width W2 and the outer width W1 of the loop antenna 24, the cell phone 10A having the antenna unit 23 of the present embodiment incorporated can enhance the passing characteristic S21 when the ends 25b of the metallic plate 25 lie between the inner width W2 and the outer width W1 of the loop antenna 24. Therefore, even when counterpart equipment operates at a different resonance frequency, wireless communication can be established over a longer communication distance by use of a mobile device in response to a plurality of types of counterpart equipment that operate at different resonance frequencies.

Although the explanation has been given in the present embodiment by means of taking as an example the cell phone as the portable wireless device, the present invention is not limited to the cell phone. The present invention can be applied to any devices, so long as the device is used as a mobile device of an RFID system, like an RFID card and RFID-contained equipment.

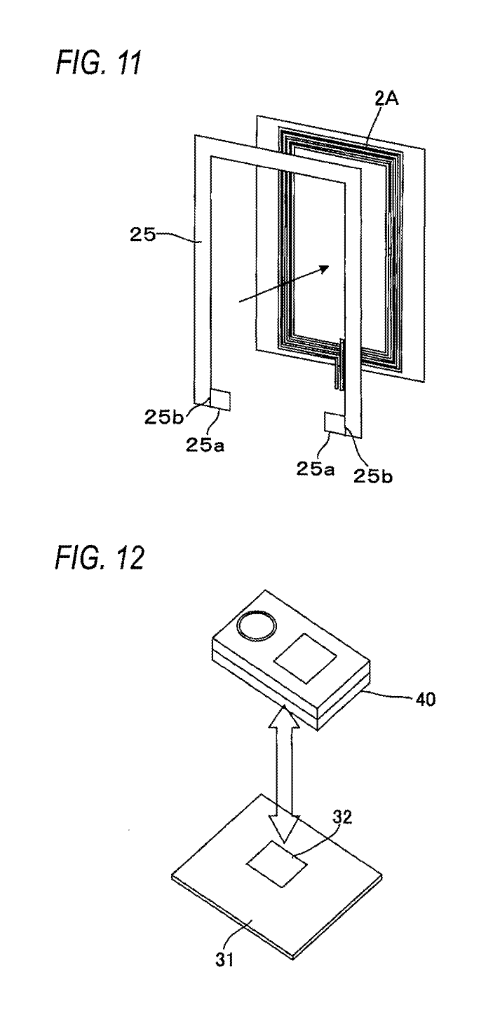

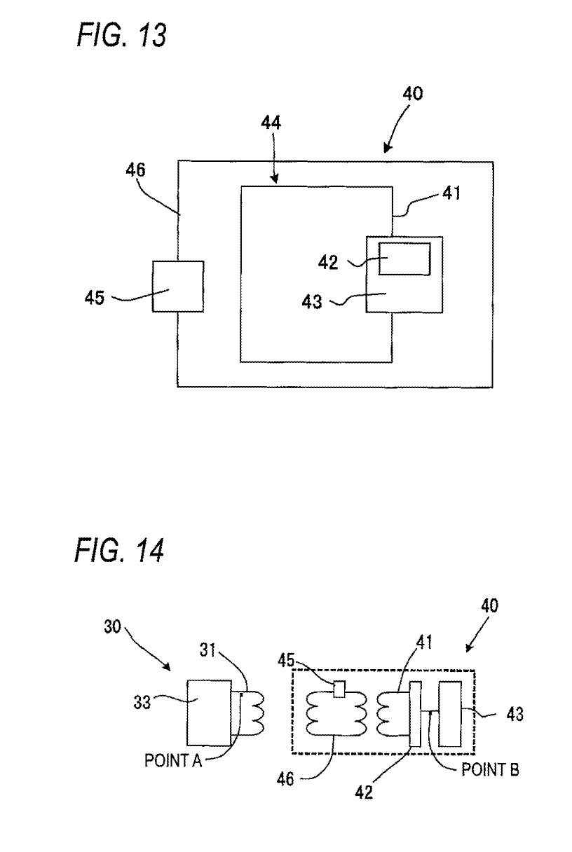

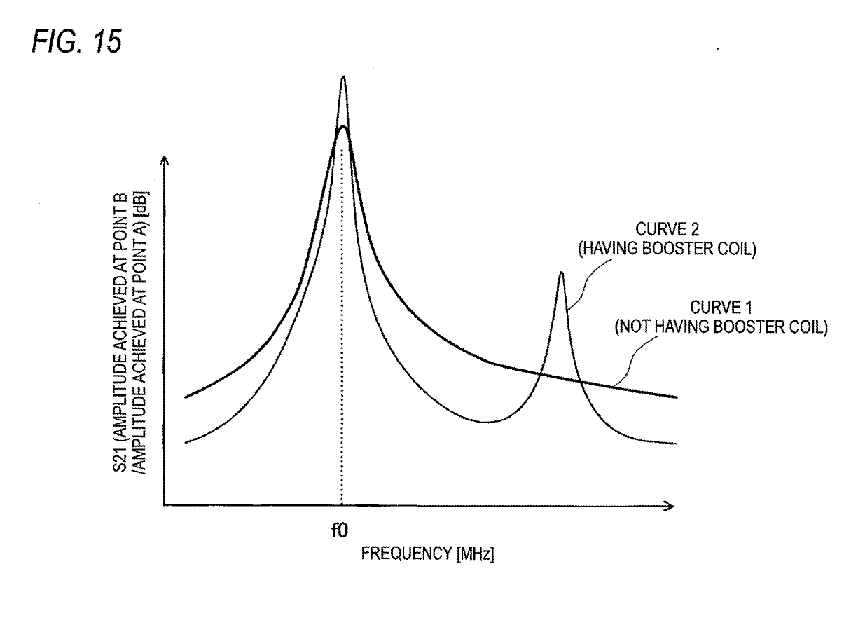

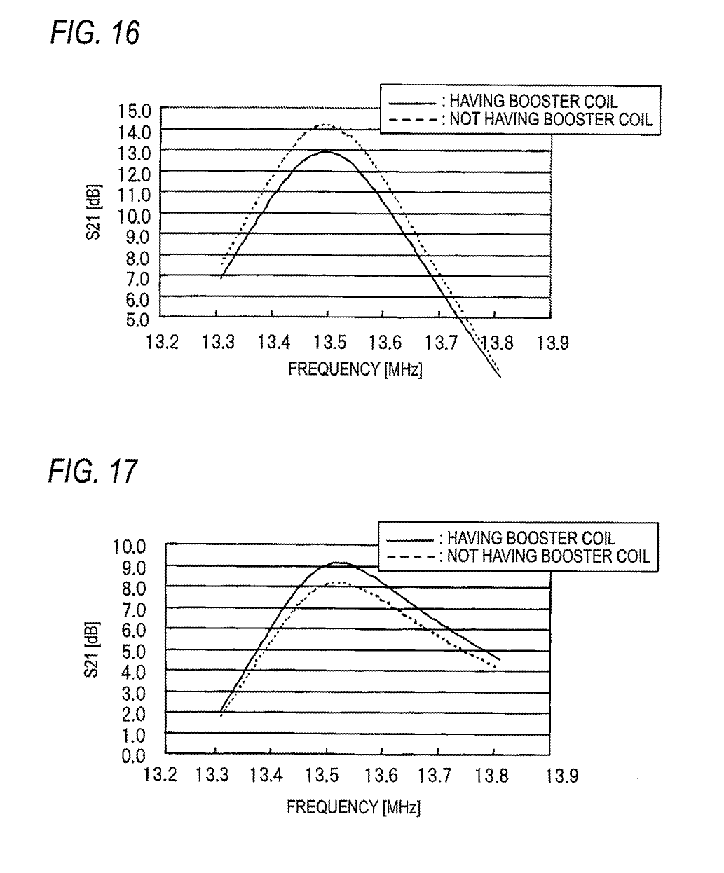

The present embodiment shows that the antenna unit 23 of the third embodiment is newly set at the time of production of the cell phone 10A. However, as shown in FIG. 11, all you need to do is to affix the metallic plate 25 to the loop antenna 2 A of the existing cell phone by means of a double-sided tape.

As a result, the antenna unit 23 of the third embodiment is built by use of the existing loop antenna 2A, whereby antenna performance of the existing cell phone can thereby be improved.

Although the metallic plate has a rectangular outer shape in the antenna units of the respective embodiments, the outer shape is not limited to the rectangular shape. The outer shape of the metallic plate is arbitrary. For instance, so long as the metallic plate is given the same outer shape as that of the antenna of its counterpart equipment, the passing characteristic 21 can be further enhanced.

In each of the antenna units of the respective embodiments, when the metallic plate is fixed to the enclosure, a conductive adhesive can be used, but a nonconductive adhesive can also be used.

In each of the antenna units of the respective embodiments, a material of the metallic plate can be a hard material or a sheet-like flexible material. In particular, even when a portion of the enclosure of the cell phone that is partially or wholly made up of a metallic plate has curvatures, the metallic plate can be deformed in agreement with the curvatures, so long as the metallic plate is formed from a sheet-like flexible material.

In each of the antenna units of the respective embodiments, it is better not to provide a magnetic substance (e.g., a magnetic sheet) on the metallic plate, so long as communication standards required to establish communication with counterpart equipment are fulfilled.

Although the present invention has been described in detail by reference to the specific embodiments, it is manifest to those skilled in the art that the present invention be susceptible to various alterations or modifications without departing from the spirit and scope of the invention.

The present patent application is based on Japanese Patent Application (JP-2009-150009) filed on Jun. 24, 2009, and Japanese Patent Application (JP-2010-054642) filed on Mar. 11, 2010, the entire subject matters of which are incorporated herein by reference.

### INDUSTRIAL APPLICABILITY

The antenna unit of the present invention and the portable wireless device equipped with the same can operate in response to a plurality of types of counterpart equipment that operate at different resonance frequencies while improving its passing characteristic and hence are useful as; for instance, an antenna unit of a cell phone.

### DESCRIPTIONS OF THE REFERENCE NUMERALS AND SYMBOLS

1, 23 ANTENNA UNIT
1A ANTENNA BLOCK
2, 24 LOOP ANTENNA
3, 25 METALLIC PLATE
3a, 25a OPEN END
4 RESONANCE CIRCUIT
5 COMMUNICATION CIRCUIT BLOCK
7, 51 MAGNETIC SHEET
8 REAR METALLIC PLATE
10, 10A CELL PHONE
13, 13A LOWER ENCLOSURE BODY
17, 17A BOTTOM PLATE
18 RECTANGULAR HOLE
18a OPENING
20 RFID BLOCK
22 ANTENNA BLOCK
25b END

1. An antenna unit that performs wireless communication originating from induction coupling, the antenna unit comprising:
a loop antenna coiled by a conductor in a planar shape; and
a metallic plate that partially encloses a circumference of the loop antenna and that is placed on substantially a same plane where the loop antenna is laid, thereby acting as an auxiliary antenna for enhancing a gain of the loop antenna.

2. An antenna unit that performs wireless communication originating from induction coupling, the antenna unit comprising:
a loop antenna coiled by a conductor in a planar shape; and
a metallic plate that is positioned while displaced from the loop antenna in one direction and that partially encloses a circumference of the loop antenna when viewed from the direction, thereby acting as an auxiliary antenna for enhancing a gain of the loop antenna, wherein each of ends of the metallic plate overlaps a portion of the loop antenna when viewed from the direction.

3. The antenna unit according to claim 2, wherein each of the ends of the metallic plate lies between the innermost coil portion and the outermost coil portion of the coil of the loop antenna.

4. The antenna unit according to claim 1, wherein the metal plate is made of a flexible material.

5. A portable wireless device having the antenna unit defined in claim 2 incorporated in an enclosure.

6. The portable wireless device according to claim 8, wherein the metallic plate of the antenna unit is made up of a metallic enclosure of the portable wireless device.

7. The antenna unit according to claim 2, wherein the metal plate is made of a flexible material.

8. A portable wireless device having the antenna unit defined in claim 1 incorporated in an enclosure.

9. The portable wireless device according to claim 5, wherein the metallic plate of the antenna unit is made up of a metallic enclosure of the portable wireless device.

10. The antenna unit according to claim 1, wherein the metallic plate does not lie inside of the loop antenna within substantially the same plane.

11. The antenna unit according to claim 2, wherein the metallic plate does not lie inside of the loop antenna when viewed from the direction.
